(19) United States
(12) Patent Application Publication
(10) Pub. No.: US 2006/0050475 A1
(43) Pub. Date: Mar. 9, 2006

(54) Portable electronic device

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/094,736

(22) Filed: Mar. 30, 2005

(30) Foreign Application Priority Data
Sep. 4, 2004 (TW) 93109877

(51) Int. Cl. G06F 1/16

(52) U.S. Cl. 361/683

(57) ABSTRACT

A portable electronic device includes a case (11) made of flexible plastic material, a display assembly (13) made of flexural E-paper, an FPC (flexible printed circuit) board, and some electronic components made from organic material. The case defines a cavity, and the display assembly, the FPC and the electronic components are all set in the cavity. The portable electronic device is capable of flexing so that its figuration can be easily changed in manufacture. Further, the size of the portable electronic device can be significantly reduced.

### BACKGROUND OF THE INVENTION

1. Field of the Invention

The present invention relates to portable electronic devices, such as mobile phones, personal digital assistants, portable recording devices, portable reproducing devices and portable radio receives.

2. Prior Art

Nowadays, portable electronic devices such as mobile phones and PDAs (personal digital assistants) are in widespread use around the world. There is more and more demand for higher quality and serviceability of these portable electronic devices. The main case of such portable electronic devices is frequently sized for convenient portability. For example, a mobile phone can usually fit into the breast pocket of a dress shirt. Usually, the case of a portable electronic device is made of hard plastic or metal, and contains an LCD (liquid crystal display), a hard PCB (printed circuit board) and a lithium battery made of hard material. Such portable electronic devices can not be flexed or bent, and the surface of the case is easily scratched. In addition, the portable electronic device is easily damaged if it falls to the ground. Furthermore, the thickness of portable electronic devices such as mobile phones is approximately 10˜15 mm. However consumers ideally prefer even thinner portable electronic devices for even more portability and convenience.

Therefore, a new portable electronic device is desired in order to overcome the above-described shortcomings.

### SUMMARY OF THE INVENTION

It is therefore an object of the present invention to provide a relatively smaller portable electronic device capable of flexing so that its figuration can also be changed easily.

An exemplary embodiment of the present invention provides a portable electronic device comprising a case made of flexible plastic material, a display assembly made of flexural E-paper, an FPC (flexible printed circuit) board, and some electronic components made from organic material. The case defines a cavity and the display assembly, the FPC and the electronic components are all set in the cavity.

Because the portable electronic device has the case made of flexible plastic material, the display assembly made of flexural E-paper, the FPC (flexible printed circuit) board, and the electronic components made of organic material, the portable electronic device is capable of flexing so that its figuration can be easily changed in manufacture. In addition, the size of the portable electronic device can be significantly reduced.

The above and other objects, advantages and novel features of the invention will become more apparent from the following detailed description when taken in conjunction with the accompanying drawings.

### BRIEF DESCRIPTION OF THE DRAWINGS

FIG. 1 is an isometric view of a portable electronic device according to a preferred embodiment of the present invention.

FIG. 2 is a plan view of a portable electronic device according to another embodiment of the present invention.

### DETAILED DESCRIPTION OF THE INVENTION

A portable electronic device in a preferred embodiment according to the present invention is a mobile phone.

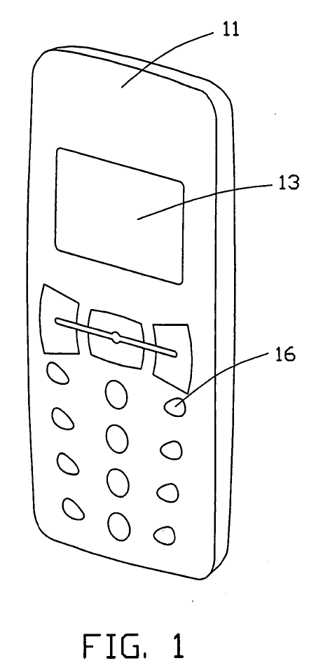

Referring to FIG. 1, the mobile phone comprises a case 11, a display assembly 13 for outputting information, an FPC (flexible printed circuit) board (not shown) as a flexible connection means, a plurality of electronic components (not shown) on the FPC board, a battery for supplying power for the mobile phone, and a keypad (not labeled). Both of the display assembly 13 and the keypad are defined together as a user interface, and the display assembly 13, the FPC board, the battery and the keypad are all viewed as large-space-occupying components of the mobile phone. The case 11 defines a cavity. The display assembly 13, the FPC, the electronic components and the keypad are all received in the cavity. There are a plurality of command keys 16 on the keypad. The case 11 has two main surfaces. A display window (not labeled) and some command key holes (not labeled) are defined in a top one of the main surfaces, so that the display assembly 13 and the keypad can protrude from the top surface.

The case 11 is made of flexible plastic material, for example, PET (polyethylene terephthalate) or PC (polycarbonate). Such flexible plastic material has good electrical insulation and thermal conductivity, so as to help ensure that the mobile phone can function normally.

The display assembly 13 is made of flexible E-paper, and, for example, may be an electrophoretic display or an OLED (organic light-emitting diode). The E-paper is easy to read, light in weight, and ergonomically sound. The fundamental theory of the electrophoretic display is: first, providing some macro transparent capsules, some liquid of dark color such as blue liquid, some light colored charged particles, and a film with a transparent electrode; then putting the blue liquid and the light colored charged particles in the macro transparent capsules; and connecting the macro transparent capsules to the film with the transparent electrode using adhesive. The film with the transparent electrode can generate an electric field. The electric field can be adjusted to make the light colored charged particles undergo electrophoresis, so that the electrophoretic display can show images made up of white and cyan elements. In addition, the electrophoretic display can be made very thin. If a plastic board is used as the motherboard of the electrophoretic display, the electrophoretic display can be bent like a sheet of plastic. Compared with an LCD, an OLED display has advantages such as: being very light, being very thin (less than 1 mm), excellent brightness, and a wide viewing angle (up to 170 degrees). Because the electrophoretic display can illuminate itself (unlike, e.g., an ITO touch panel), it has ultra low voltage, a high response velocity (1000 times that of an LCD), excellent definition, low heat generation, good shock resistance, good flexural performance, and a low manufacturing costs.

The electronic components on the FPC board include an IC (integrated circuit) chip, and a transistor made from organic material. The electronic components form an integrated circuit for executing the electronic functions of the mobile phone. In addition, the electronic components on the FPC board are typically small, inexpensive and somewhat flexible.

The battery is preferably a lithium polymer battery. In the lithium polymer battery, solid polymer lithium electrolyte is used instead of the more conventional lithium ion electrolyte of a lithium ion battery. The lithium polymer battery is safe and easily manufactured, so that it can be made quite thin and in any of various different shapes.

The keypad and other components are preferably made of flexible material. For example, the keypad can be woolen. The woolen keypad is generally produced by soft exchange technology. The woolen keypad is typically made from natural wool and a special fiber. The resistance of the special fiber can be changed in the order of several tens of times, such that the special fiber is changed in character from an electrical conductor to an electrical insulator. Thus, information produced by the keypad can be transferred to electronic components in the mobile phone.

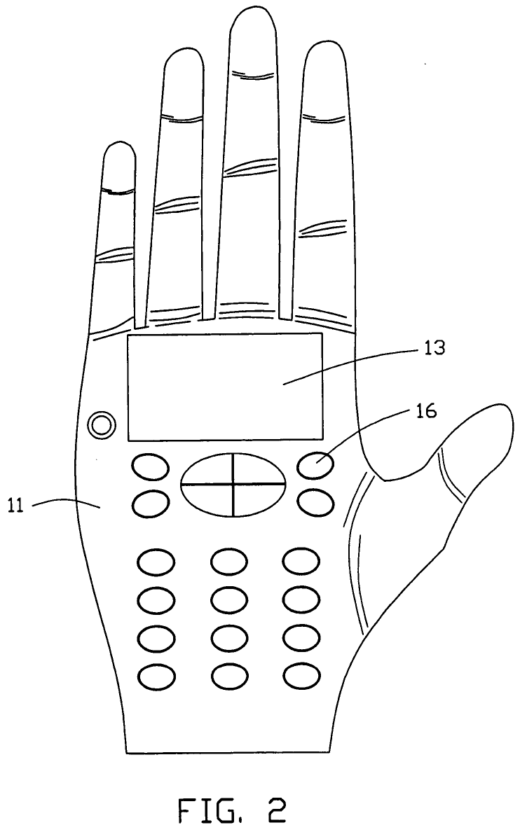

The shape of the mobile phone can be readily configured as desired in manufacture. In particular to satisfy various consumer requirements, the mobile phone can be made into different kinds of shapes such as a glove shape (see FIG. 2). A user can wear the glove shaped mobile phone on one hand, and operate the mobile phone using the other hand.

In summary, a portable electronic device such as the mobile phone has the case made of flexible plastic material, the display assembly made of flexural E-paper, the FPC (flexible printed circuit) board, and the electronic components made of organic material. Therefore the portable electronic device is capable of flexing so that its figuration can be easily changed in manufacture. In addition, the size of the portable electronic device can be significantly reduced.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A portable electronic device comprising:
a case made of flexible plastic material and defining a cavity;
a display assembly made of flexible E-paper;
electronic components made from organic material; and
an FPC (flexible printed circuit) board;
wherein, the display assembly, the FPC board and the electronic components are all received in the cavity.

2. The portable electronic device according to claim 1, wherein the case is made of material with good electrical insulation and thermal conductivity.

3. The portable electronic device according to claim 2, wherein the case is made of PET (polyethylene terephthalate).

4. The portable electronic device according to claim 1, wherein the case is made of PC (Polycarbonate).

5. The portable electronic device according to claim 1, wherein the display assembly comprises an electrophoretic display.

6. The portable electronic device according to claim 1, wherein the display assembly comprises an OLED(organic light-emitting diode) display.

7. The portable electronic device according to claim 1, wherein the electronic components comprise an IC (integrated circuit) and a transistor made from organic material.

8. The portable electronic device according to claim 1, further comprising a keypad made from flexible material, the keypad comprising a plurality of command keys.

9. The portable electronic device according to claim 8, wherein the case has a display window and a plurality of command key holes, so that the display assembly and the keypad are exposed for use by a user.

10. The portable electronic device according to claim 1, wherein the keypad is made from wool and/or fiber.

11. The portable electronic device according to claim 1, further comprising a lithium polymer battery.

12. A portable electronic device comprising:
a case made of flexible material and enclosing said portable electronic device;
a user interface exposed to an outside of said case so as to communicate said portable electronic device with users of said portable electronic device; and
a flexible connection means having electronic components electrically connected therewith, and installed in said case to electrically connect said electronic components with said user interface;
wherein said user interface, said flexible connection means and said electronic components are arranged in said case so that portions of said portable electronic device are capable of being flexibly shaped in use.

13. The portable electronic device according to claim 12, wherein said user interface includes a display assembly and a keypad disposed next to said display assembly.

14. The portable electronic device according to claim 12, wherein said flexible connection means is a flexible printed circuit board (FPC board).

15. A method to manufacture a portable electronic device, comprising the steps of:
selecting one of flexible material for making a case enclosing said portable electronic device;
selectively using flexible material to make large-space-occupying components of said portable electronic device;
electrically connecting said large-space-occupying components with other components of said portable electronic device; and
assembling said large-space-occupying components and other components of said portable electronic device into said case so that said portable electronic device is capable of being flexibly shaped in use based on arrangement of said large-space-occupying components and other components in said case.

16. The method according to claim 15, wherein said large-space-occupying components of said portable electronic device include a flexible printed circuit board (FPC board), a display assembly, a keypad and a battery.
